(19) United States
(12) Patent Application Publication
(10) Pub. No.: US 2014/0191712 A1
(43) Pub. Date: Jul. 10, 2014

(54) POWER DELIVERY INCLUDING OUT-OF-BAND COMMUNICATION

(71) Applicants: Adam D. REA, Lynnwood, WA (US); Evan R. GREEN, Beaverton, OR (US); Robert PAXMAN, Hillsboro, OR (US); Ronald W. GALLAHAN, Portland, OR (US)

(72) Inventors: Adam D. REA, Lynnwood, WA (US); Evan R. GREEN, Beaverton, OR (US); Robert PAXMAN, Hillsboro, OR (US); Ronald W. GALLAHAN, Portland, OR (US)

(21) Appl. No.: 13/738,738

(22) Filed: Jan. 10, 2013

(51) Int. Cl. H02J 7/00

(52) U.S. Cl. CPC H02J 7/00
USPC 320/108; 320/137; 320/162

(57) ABSTRACT

This disclosure is directed to power delivery including out-of-band communication. In general, a device to be charged and a charging device may interact using two separate wireless signals. A first wireless signal (e.g., a radio frequency (RF) signal) may be employed to charge the device. A second wireless signal of a different type (e.g., an infrared (IR) signal) may be employed for inter-device communication. An example device may comprise a power module to receive a first wireless signal, a transmitter to transmit a second wireless signal, and a charging control module. The first wireless signal may be for conveying power from a charging device to the device, the second wireless signal may be for transmitting information from the device to the charging device, and the charging control module may be to cause the transmitter to transmit the second wireless signal based on an indication received from the power module.

### TECHNICAL FIELD

The present disclosure relates to systems for charging devices, and more particularly, to charging systems including wireless communication between a charging system and a device.

### BACKGROUND

Wireless technology continues to evolve, and with it so does the wide array of devices available in the marketplace. Further to emerging cellular handsets and smartphones that have become integral to the lives of consumers, existing applications not traditionally equipped with any means to communicate are becoming wirelessly-enabled. For example, various industrial, commercial and/or residential systems may employ wireless communication for the purposes of monitoring, reporting, control, etc. As the application of wireless communication expands, the powering of wireless devices may become a concern. This concern falls mainly in the realm of mobile communication devices wherein the expanding applicability of wireless communication implies a corresponding increase in power consumption. One way in which the power problem may be addressed is increasing battery size and/or device efficiency. Development in both of these areas continues, but may be impeded by the desire to control wireless device size, cost, etc.

Another manner by which mobile wireless device power consumption may be addressed is by facilitating easier recharging of devices. In existing systems, battery-driven devices must be periodically coupled to another power source (e.g., grid power, solar power, fuel cell, etc.) for recharging. Typically this involves maintaining a recharger specific to the device being charged, mechanically coupling the device to a charging cord for some period of time, etc. Developments in the area of recharging are being developed to replace this cumbersome process. For example, wireless charging may remove the requirement of having charging equipment corresponding to a particular device to be charged. However, the performance of existing wireless charging systems may be negatively impacted by wireless communication between a device to be charged and the charging system being conducted over the same wireless signal that is used to charge the device.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example of power delivery including out-of-band communication in accordance with at least one embodiment of the present disclosure;

FIG. 2 illustrates an example configuration for a device usable in accordance with at least one embodiment of the present disclosure;

FIG. 3 illustrates an alternative example configuration for a device usable in accordance with at least one embodiment of the present disclosure;

FIG. 4 illustrates examples of power and communication signal interaction in accordance with at least one embodiment of the present disclosure; and

FIG. 5 illustrates example operations related to power delivery including out-of-band communication in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to power delivery including out-of-band communication. In general, a device to be charged and a charging device may interact using two separate wireless signals. A first wireless signal (e.g., a radio frequency (RF) signal) may be employed to charge the device. A second wireless signal of a different type (e.g., an infrared (IR) signal) may be employed for inter-device communication. Communication occurring between the device and the charging device may, for example, configure/initiate the charging process, monitor/control the charging process, discontinue the charging process in the event of a problem, etc.

In one embodiment, a device may comprise, for example, a power module to receive a first wireless signal, a transmitter to transmit a second wireless signal, and a charging control module. The first wireless signal may be for conveying power from a charging device to the device. The second wireless signal may be for transmitting information from the device to the charging device. The charging control module may be to cause the transmitter to transmit the second wireless signal based on an indication received from the power module. In one example configuration, the power module may comprise wireless charging circuitry to receive the first wireless signal (e.g., an RF signal). Given the first wireless signal is an RF signal, the wireless charging circuitry may include a coil to generate a charging current based on the RF signal. The second signal may be a close-proximity wireless communication signal (e.g., an IR signal).

In the same or a different embodiment, the transmitter may be part of the power module. It may also be possible for the charging control module to be part of the power module. The indication that is received in the charging control module from the power module may be related to at least one of the first wireless signal (e.g., whether the first wireless signal is being received or not being received, whether the first wireless signal is too weak or too strong, etc.) or may be related to a device power condition (e.g., the amount of power currently stored in the device, the rate at which the device is charging, events such as an error or malfunction in the power module, etc.). In response to receiving an indication from the power module, the charging control module may cause the transmitter to transmit information including at least one of status or instructions related to the indication. In one embodiment, the device may further comprise a receiver to receive a third wireless signal for conveying information from the charging device to the device. An example method consistent with an embodiment of the present disclosure may comprise receiving a notification from a power module in a device that a first wireless signal has been received, and causing a second wireless signal to be transmitted by a transmitter in the device, the second wireless signal initializing power transfer to the device via the first wireless signal.

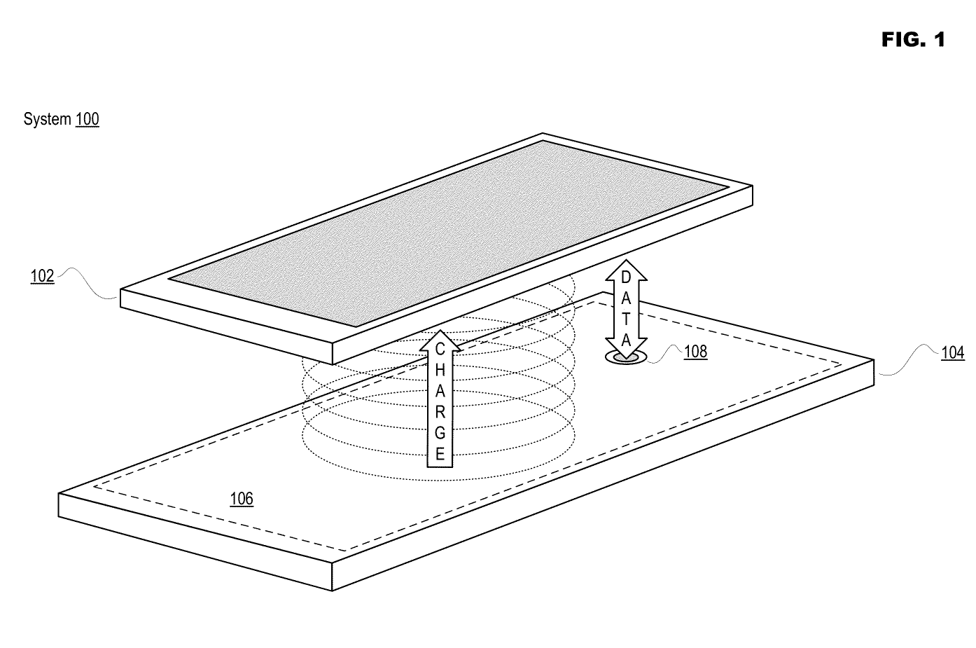

FIG. 1 illustrates an example of power delivery including out-of-band communication in accordance with at least one embodiment of the present disclosure. System 100 may include, for example, at least one device to be charged 102 and a charging device 104. Device 102 may be, for example, a mobile communication device such as a cellular handset or a smartphone based on the Android® operating system (OS), iOS®, Windows® OS, Blackberry® OS, Palm® OS, Symbian® OS, etc., a mobile computing device such as a tablet computer like an iPad®, Galaxy Tab®, Kindle Fire®, etc., an Ultrabook® including a low-power chipset manufactured by Intel Corporation, a netbook, a notebook, a laptop, a palmtop, etc. Device 102 may be configured to receive at least a charging signal and a separate communication signal from charging device 104.

Charging device 104 may comprise at least charging signal transmitter 106 and a wireless signal receiver 108. While in FIG. 1 charging device is illustrated as being configured to charge only one device 102, embodiments consistent with the present disclosure are not limited to only this configuration. Charging device 104 may be configured to charge multiple devices 102 by, for example, including multiple charging signal transmitters 106 and wireless signal receivers 108. In one example of operation, device 102 may be proximate to or placed into contact with charging device 104 (e.g., based on the effective range of the charging signal generated by charging signal transmitter 106). Device 102 may utilize the charging signal for charging its power source. For example, an RF signal generated by charging device 104 may induce a current in a coil within device 102, the current being used to charge a battery in device 102.

In addition, unidirectional or bidirectional communication may be conducted over a wireless signal different than the charging signal. For example, device 102 may include an IR transmitter configured to transmit information from device 102 to wireless signal receiver 108. A variety of information may be transmitted between device 102 and charging device 104. For example, upon sensing a charging signal, device 102 may transmit initialization information to charging device 104 (e.g., device identification and/or type, charging system tolerances, etc.) to configure charging signal transmitter 106. The configuration of charging device 104 may be important to allow device 102 to be charged in an efficient and safe manner. Moreover, device 102 may continue to communicate with charging device 104 to provide updates on the charge level of device 102, to increase or decrease the charge rate, to alert as to any events that are detected (e.g., problems, malfunctions, etc.), to inform charging device 104 that charging is complete so that charging device 104 may discontinue transmission of the charging signal to save power, etc. In the instance of bidirectional communication, wireless signal receiver 108 may actually be a wireless transceiver (e.g., capable of transmitting and receiving information wirelessly) or may be coupled with a wireless transmitter to transmit wireless communication signals to device 102. Charging device 104 may then interact with device 102 to, for example, inform device 102 of the capabilities of charging device 104, indicate that charging is about to commence, to provide alerts in regard to problematic events in charging device 104, etc.

At least one advantage that may be realized by employing example system 100 as shown in FIG. 1 is that communication may be maintained between device 102 and charging device 104 without impacting either the charging or communication operations. Communication in existing wireless charging systems may be accomplished through load modulation. However, because it is desirable to exhibit a high quality factor, the narrow band of this power transfer arrangement necessarily limits the bandwidth available for communication. Moreover, using load modulation to imbed even unidirectional communication in the charging signal (e.g., from device being charged 102 to charging device 104) convolutes the regulatory requirements necessary for reliability and/or safety certification (e.g., power levels associated with intentional and spurious wireless communication emissions are controlled based on a stricter regulatory classification than non-communication signals). Separating the power and communication signals (e.g., so that communication signals are out-of-band), consistent with embodiments of the present disclosure, helps to alleviate these issues because the charging signal is used only for charging, resulting in better communication flexibility and more straightforward regulatory part classification.

Another implication of splitting power transfer and communication, specifically over a low power IR-based link, is that it is possible to put the communication elements functionally near to the other processing elements needed for RF-based wireless power transfer/charging. The impulse of the RF power probe can be used as the bootstrap power for the communication elements and be used to identify a variety of negative scenarios. Examples of negative scenarios include, but are not limited to, enabling foreign object detection (FOD) in that RF loading may occur without RF response, improper alignment of the transmit and receive elements in the RF power delivery system, etc.

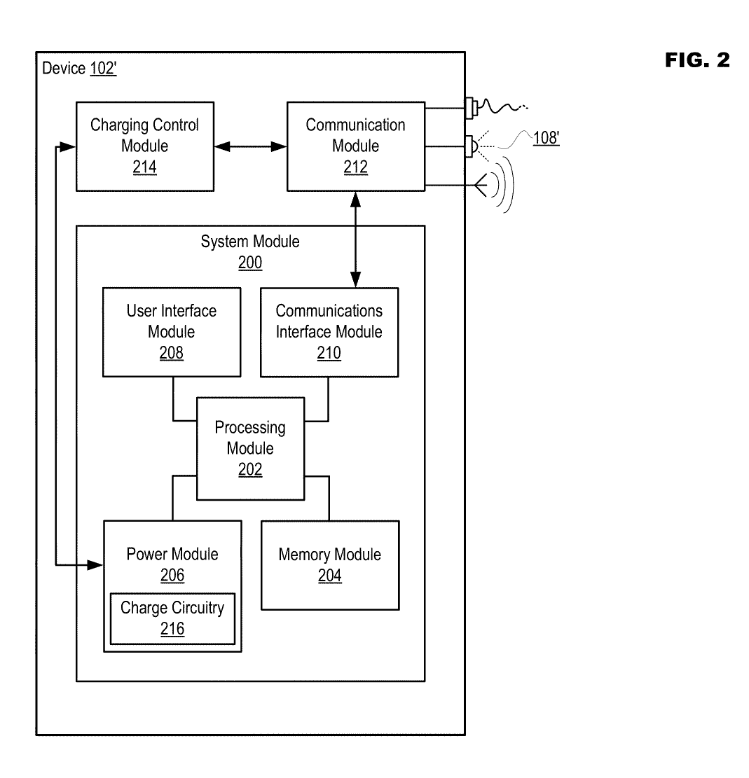

FIG. 2 illustrates an example configuration for device 102′ usable in accordance with at least one embodiment of the present disclosure. In particular, device 102′ may perform example functionality such as disclosed in FIG. 1. Device 102′ is meant only as an example of equipment usable in accordance with embodiments consistent with the present disclosure, and is not meant to limit these various embodiments to any particular manner of implementation.

Device 102′ may comprise system module 200 configured to generally manage device operations. System module 200 may include, for example, processing module 202, memory module 204, power module 206, user interface module 208 and communication interface module 210 that may be configured to interact with communication module 212. Device 102′ may also include charging control module 214 configured to interact with at least power module 206 and communication module 212. While communication module 212 and charging control module 214 are illustrated separate from system module 200, this is merely for the sake of explanation herein. Some or all of the functionality associated with communication module 212 and/or charging control module 214 may also be incorporated within system module 200.

In device 102′, processing module 202 may comprise one or more processors situated in separate components, or alternatively, may comprise one or more processing cores embodied in a single component (e.g., in a System-on-a-Chip (SOC) configuration) and any processor-related support circuitry (e.g., bridging interfaces, etc.). Example processors may include, but are not limited to, various x86-based microprocessors available from the Intel Corporation including those in the Pentium, Xeon, Itanium, Celeron, Atom, Core i-series product families. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in device 102′. Some or all of the functionality commonly associated with the support circuitry may also be included in the same physical package as the processor (e.g., an SOC package like the Sandy Bridge integrated circuit available from the Intel Corporation).

Processing module 202 may be configured to execute various instructions in device 102′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) or read-only memory (ROM) in a fixed or removable format. RAM may include memory configured to hold information during the operation of device 102′ such as, for example, static RAM (SRAM) or Dynamic RAM (DRAM). ROM may include memories such as bios memory configured to provide instructions when device 102′ activates, programmable memories such as electronic programmable ROMs (EPROMS), Flash, etc. Other fixed and/or removable memory may include magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), etc. Power module 206 may include internal power sources (e.g., a battery) and/or external power sources (e.g., electromechanical or solar generator, power grid, fuel cell, etc.), and related circuitry configured to supply device 102′ with the power needed to operate.

User interface module 208 may include circuitry configured to allow users to interact with device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, lighted/flashing indicators, electromechanical components for vibration, motion, etc.). Communication interface module 210 may be configured to handle packet routing and other control functions for communication module 212, which may include resources configured to support wired and/or wireless communications. Wired communications may include serial and parallel wired mediums such as, for example, Ethernet, Universal Serial Bus (USB), Firewire, Digital Visual Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), optical character recognition (OCR), magnetic character sensing, etc.), short-range wireless mediums (e.g., Bluetooth, WLAN, Wi-Fi, etc.) and long range wireless mediums (e.g., cellular, satellite, etc.). In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission.

In the embodiment illustrated in FIG. 2, charging control module 214 may be coupled to at least communication module 212 and power module 206 in device 102′. Moreover, power module 206 may comprise charge circuitry 216 to receive a power signal from charging device 104. In an example of operation, charging control module 214 may be able to communicate with power module 206 to determine the status of the charging signal received by charge circuitry 216 (e.g., from charging device 104) and/or the device power condition. For example, the status of the charge signal may include notification that the charging signal is being received, is not being received, needs to be increased or decreased, etc. Example indications corresponding to device power condition may include the current power level of batteries in device 102′, the estimated time until the batteries are at full charge, problems being experienced with device 102′, etc. Charging control module 214 may receive these indications and make determinations as to information that needs to be transmitted to charging device 104. For example, charging control module 214 may cause communication control module 212 to transmit status or instructions to charging device 104 via close-proximity wireless transmitter 108′ (e.g., such as an IR wireless transmitter). Status information may include, for example, the current power status of device 102′ (e.g., determined from indications received from power module 206), or alerts as to any problems that may be occurring (e.g., no charging signal being received from charging device 104, the charging signal being at too low or high a power output, charging system malfunctions, etc.). Charging module 214 may also instruct charging device 104 to, for example, start/cease transmitting a charging signal, raise/lower a charging signal, etc.

In one embodiment, communication module 212 may also be able to receive information from charging device 104. For example, close-proximity wireless transmitter 108′ may actually be a transceiver (e.g., able to both transmit and receive), or may be paired with a separate close-proximity wireless receiver. Bidirectional wireless communication may allow charging device 104 to, for example, provide information on the abilities of charging device 104, to indicate to charging control module 214 when charging signal transmission has initiated, to acknowledge the receipt of status or instructions from charging control module 214, to alert charging control module 214 as to problems, etc.

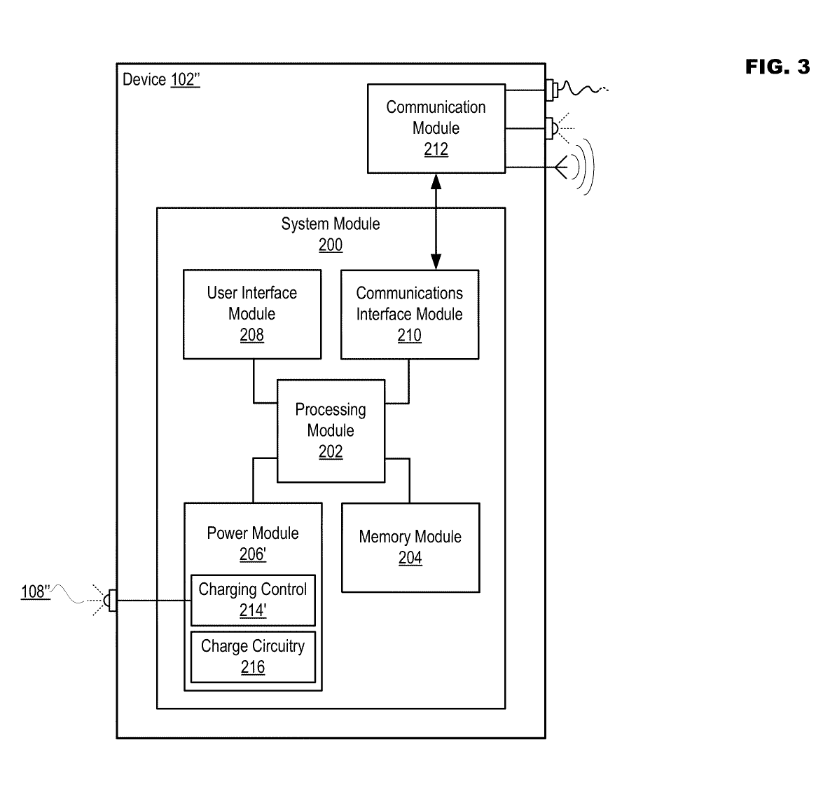

FIG. 3 illustrates an alternative example configuration for device 102″ usable in accordance with at least one embodiment of the present disclosure. Device 102″ may be similar to device 102′ except for the configuration of charging control module 214′ and close-proximity transmitter 108″. In particular, charging control module 214′ may be relocated to power module 206′ along with charge circuitry 216. A separate close-proximity transmitter 108″ may also be dedicated for exclusive use by charging control module 214′. The example configured shown in FIG. 3 localizes all of the charging-related functionality into power module 206′. By tightly coupling close-proximity (e.g., IR) communication with power transfer (e.g., the reception of the charging signal by charge circuitry 216), a tight control and response loop can be maintained that is independent of higher level factors. For example, the communication stack may be contained in the same logic as the power delivery element, helping to ensure real-time response that isn't dependent on the OS or protocol stack in communication module 212. Low latency and speed of transfer is very important when trying to implement a closed loop regulation regimen on the power receiver element. This has been a goal of using in-band communication in the past, but has not been realized to its utmost because of the limitations inherent in in-band communication.

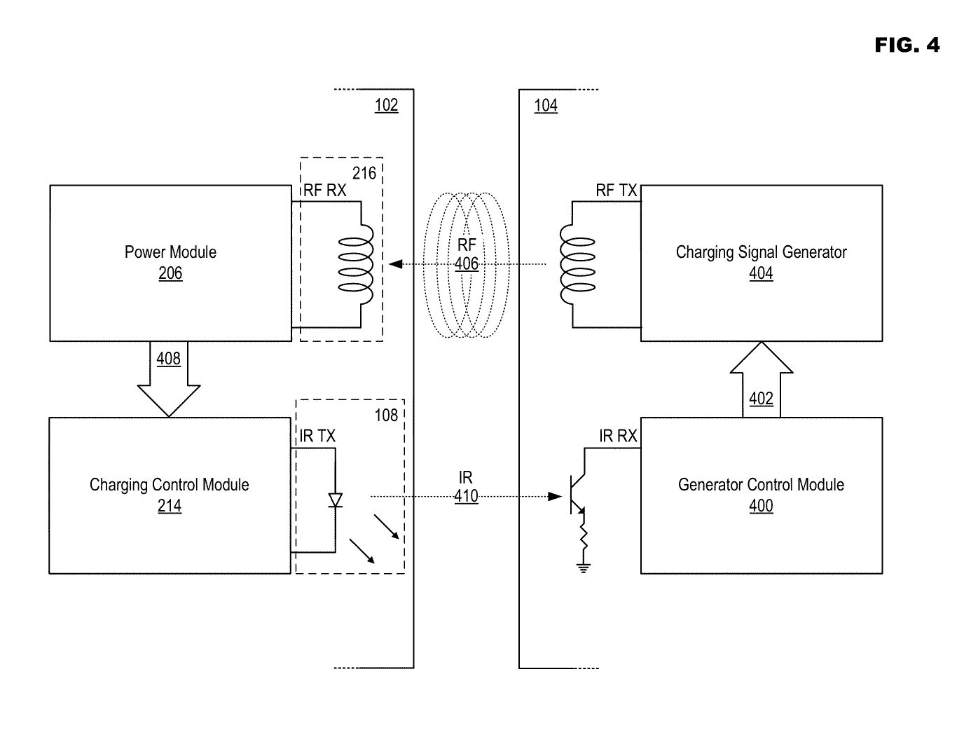

FIG. 4 illustrates examples of power and communication signal interaction in accordance with at least one embodiment of the present disclosure. While FIG. 4 illustrates an example of unidirectional communication, bidirectional communication is also possible consistent with the present disclosure. Generator control module 400 in charging device 104 may control charging signal generator 404 as shown at 402. In response to control 402, charging signal generator 400 may, for example, generate a charging signal (e.g., RF charging signal 404). RF charging signal 404 may be emitted by an RF transmitter (e.g., RF TX) in charging device 104 and may, in turn, be received by charging circuitry 216 including a coil configured to receive the RF signal (e.g., RF RX) and to generate a current for charging power resources (e.g., batteries) in device 102.

Power module 206 may provide indications to charging control module 214 as shown at 408 as to the status of charging signal 406 or the device power condition. Charging module 214 may determine, based on received indications 408, that information (e.g., status or instructions) needs to be transmitted to charging device 104. Charging control module 214 may then utilize close-proximity transmitter 108 (e.g., IR TX) to transmit a signal (e.g., IR signal 410) to charging device 104. Generator control module 400 may receive IR signal 410, and may make changes to control 402 based on information (e.g., status or instructions) contained in IR signal 410. For example, generator control module 400 may cause charging signal generator 404 to start/stop generation of RF signal 406, to increase or decrease the power of RF signal 406, etc. The example interactions depicted in FIG. 4 may continue while device 102 is charging, until device 102 is removed (e.g., out of range of RF signal 406), until a problem is detected, etc.

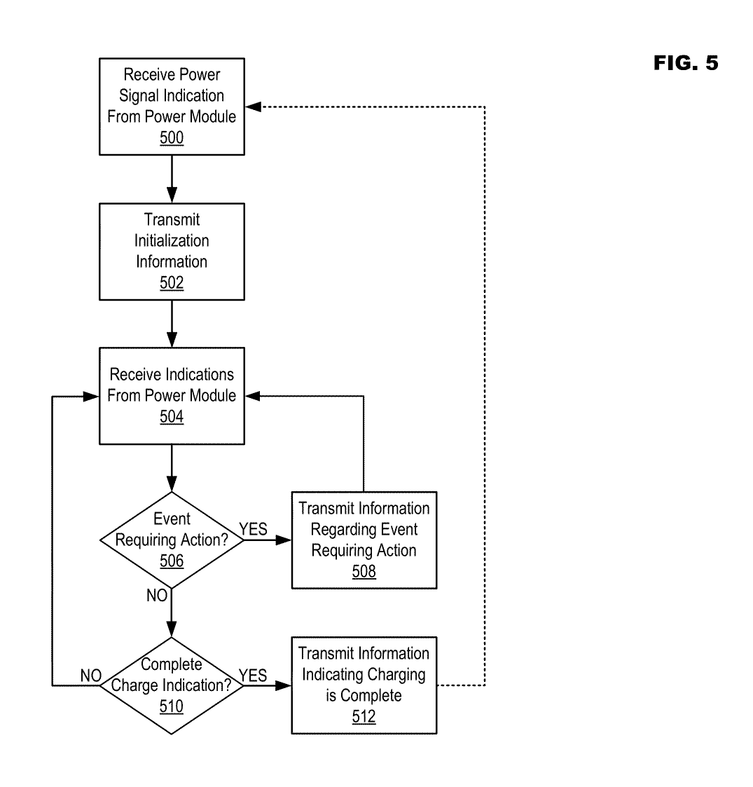

FIG. 5 illustrates example operations related to power delivery including out-of-band communication in accordance with at least one embodiment of the present disclosure. A power signal indication may be received in a charging control module in operation 500. For example, a power module in a device may detect a charging signal that causes the power module to send the indication to the charging control module. In response to receiving the indication, the charging control module may then transmit initialization information in operation 502. The initialization information may comprise, for example, device/type identification, charging system operational limitations, etc. for use by a charging device to control transmission of the charging signal.

In operation 504 indications may be received from the power module into the charging control module. A determination may then be made in operation 506 as to whether the received indications correspond to events requiring action. Example events requiring action may include, for example, non-reception of the charging signal, charging signal power being too low or high, charging system problems (e.g., malfunctions), etc. If in operation 504 it is determined that an indication corresponds to an event requiring action, then in operation 508 information may be transmitted to the charging device in response to the event (e.g., via close-proximity wireless communication). For example, at least one of status or instructions may be transmitted to the charging device to perpetuate a change in charging device operation. If the indication does not indicate an event requiring action, then in operation 510 a further determination may then be made as to whether the indication corresponds to the charging of the device being complete. If in operation 510 it is determined that charging is not complete, the in operation 504 charging may continue. Otherwise, in operation 512 information indicating that charging is complete may be transmitted to the charging device. Optionally, operation 512 may be followed by a return to operation 500 to prepare for the next instance where a power signal is received in the device.

While FIG. 5 illustrates various operations according to an embodiment, it is to be understood that not all of the operations depicted in FIG. 5 are necessary for other embodiments. Indeed, it is fully contemplated herein that in other embodiments of the present disclosure, the operations depicted in FIG. 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to power delivery including out-of-band communication. In general, a device to be charged and a charging device may interact using two separate wireless signals. A first wireless signal (e.g., a radio frequency (RF) signal) may be employed to charge the device. A second wireless signal of a different type (e.g., an infrared (IR) signal) may be employed for inter-device communication. An example device may comprise a power module to receive a first wireless signal, a transmitter to transmit a second wireless signal, and a charging control module. The first wireless signal may be for conveying power from a charging device to the device, the second wireless signal may be for transmitting information from the device to the charging device, and the charging control module may be to cause the transmitter to transmit the second wireless signal based on an indication received from the power module.

The following examples pertain to further embodiments. In one example there is provided a device. The device may include a power module to receive a first wireless signal for conveying power from a charging device to the device, a transmitter to transmit a second wireless signal for conveying information from the device to the charging device, and a charging control module to cause the transmitter to transmit the second wireless signal based on an indication received from the power module.

The above example device may be further configured, wherein the power module comprises wireless charging circuitry to receive the first wireless signal, the first wireless signal being a radio frequency (RF) signal. In this configuration the example device may be further configured, wherein the wireless charging circuitry comprises at least a coil to generate a charging current based on the RF signal.

The above example device may be further configured, alone or in combination with the above further configurations, wherein the second wireless signal is an infrared (IR) signal.

The above example device may be further configured, alone or in combination with the above further configurations, wherein the transmitter is part of the power module. In this configuration the example device may be further configured, wherein the charging control module is part of the power module.

The above example device may be further configured, alone or in combination with the above further configurations, wherein the indication relates to at least one of the first wireless signal or device power condition.

The above example device may be further configured, alone or in combination with the above further configurations, wherein the information transmitted in the second wireless signal comprises at least one of status or instructions related to the indication.

The above example device may be further configured, alone or in combination with the above further configurations, further comprising a receiver to receive a third wireless signal for conveying information from the charging device to the device.

In another example there is provided a method. The method may include receiving a notification from a power module in a device that a first wireless signal has been received, and causing a second wireless signal to be transmitted by a transmitter in the device, the second wireless signal initializing power transfer to the device via the first wireless signal.

The above example method may be further configured, wherein the first wireless signal is a radio frequency (RF) signal.

The above example method may be further configured, alone or in combination with the above further configurations, wherein the second wireless signal is an infrared (IR) signal.

The above example method may further comprise, alone or in combination with the above further configurations, receiving an indication from the power module, the indication relating to at least one of the first wireless signal or device power condition. In this configuration the example method may further comprise causing information to be transmitted via the second wireless signal, the information including at least one of status or instructions related to the indication.

In another example there is provided a system comprising at least a device and a charging device, the system being arranged to perform the method of any of the above example methods.

In another example there is provided a chipset arranged to perform any of the above example methods.

In another example there is provided at least one machine readable medium comprising a plurality of instructions that, in response to be being executed on a computing device, cause the computing device to carry out any of the above example methods.

In another example there is provided a device configured for power delivery including out-of-band communication arranged to perform any of the above example methods.

In another example there is provided a device having means to perform any of the above example methods.

In another example there is provided at least one machine-readable storage medium having stored thereon individually or in combination, instructions that when executed by one or more processors result in the system carrying out any of the above example methods.

In another example there is provided a device. The device may include a power module to receive a first wireless signal for conveying power from a charging device to the device, a transmitter to transmit a second wireless signal for conveying information from the device to the charging device, and a charging control module to cause the transmitter to transmit the second wireless signal based on an indication received from the power module.

The above example device may be further configured, wherein the power module comprises wireless charging circuitry to receive the first wireless signal, the first wireless signal being a radio frequency (RF) signal, the wireless charging circuitry comprising at least a coil to generate a charging current based on the RF signal.

The above example device may be further configured, alone or in combination with the above further configurations, wherein the second wireless signal is an infrared (IR) signal.

The above example device may be further configured, alone or in combination with the above further configurations, wherein the transmitter and the charging control module are part of the power module.

The above example device may be further configured, alone or in combination with the above further configurations, wherein the indication relates to at least one of the first wireless signal or device power condition.

The above example device may be further configured, alone or in combination with the above further configurations, wherein the information transmitted in the second wireless signal comprises at least one of status or instructions related to the indication.

The above example device may be further comprise, alone or in combination with the above further configurations, a receiver to receive a third wireless signal for conveying information from the charging device to the device.

In another example there is provided a method. The method may include receiving a notification from a power module in a device that a first wireless signal has been received, and causing a second wireless signal to be transmitted by a transmitter in the device, the second wireless signal initializing power transfer to the device via the first wireless signal.

The above example method may be further configured, wherein the first wireless signal is a radio frequency (RF) signal.

The above example method may be further configured, alone or in combination with the above further configurations, wherein the second wireless signal is an infrared (IR) signal.

The above example method may further comprise, alone or in combination with the above further configurations, receiving an indication from the power module, the indication relating to at least one of the first wireless signal or device power condition. In this configuration the example method may further comprise causing information to be transmitted via the second wireless signal, the information including at least one of status or instructions related to the indication.

In another example there is provided a system comprising at least a device and a charging device, the system being arranged to perform any of the above example methods.

In another example there is provided a chipset arranged to perform any of the above example methods.

In another example there is provided at least one machine readable medium comprising a plurality of instructions that, in response to be being executed on a computing device, cause the computing device to carry out any of the above example methods.

In another example there is provided a device. The device may include a power module to receive a first wireless signal for conveying power from a charging device to the device, a transmitter to transmit a second wireless signal for conveying information from the device to the charging device, and a charging control module to cause the transmitter to transmit the second wireless signal based on an indication received from the power module.

The above example device may be further configured, wherein the power module comprises wireless charging circuitry to receive the first wireless signal, the first wireless signal being a radio frequency (RF) signal. In this configuration the example device may be further configured, wherein the wireless charging circuitry comprises at least a coil to generate a charging current based on the RF signal.

The above example device may be further configured, alone or in combination with the above further configurations, wherein the second wireless signal is an infrared (IR) signal.

The above example device may be further configured, alone or in combination with the above further configurations, wherein the transmitter is part of the power module. In this configuration the example device may be further configured, wherein the charging control module is part of the power module.

The above example device may be further configured, alone or in combination with the above further configurations, wherein the indication relates to at least one of the first wireless signal or device power condition.

The above example device may be further configured, alone or in combination with the above further configurations, wherein the information transmitted in the second wireless signal comprises at least one of status or instructions related to the indication.

The above example device may be further configured, alone or in combination with the above further configurations, further comprising a receiver to receive a third wireless signal for conveying information from the charging device to the device.

In another example there is provided a method. The method may include receiving a notification from a power module in a device that a first wireless signal has been received, and causing a second wireless signal to be transmitted by a transmitter in the device, the second wireless signal initializing power transfer to the device via the first wireless signal.

The above example method may be further configured, wherein the first wireless signal is a radio frequency (RF) signal.

The above example method may be further configured, alone or in combination with the above further configurations, wherein the second wireless signal is an infrared (IR) signal.

The above example method may further comprise, alone or in combination with the above further configurations, receiving an indication from the power module, the indication relating to at least one of the first wireless signal or device power condition. In this configuration the example method may further comprise causing information to be transmitted via the second wireless signal, the information including at least one of status or instructions related to the indication.

In another example there is provided a system. The system may include means for receiving a notification from a power module in a device that a first wireless signal has been received, and means for causing a second wireless signal to be transmitted by a transmitter in the device, the second wireless signal initializing power transfer to the device via the first wireless signal.

The above example system may be further configured, wherein the first wireless signal is a radio frequency (RF) signal.

The above example system may be further configured, alone or in combination with the above further configurations, wherein the second wireless signal is an infrared (IR) signal.

The above example system may further comprise, alone or in combination with the above further configurations, means for receiving an indication from the power module, the indication relating to at least one of the first wireless signal or device power condition. In this configuration the example system may further comprise means for causing information to be transmitted via the second wireless signal, the information including at least one of status or instructions related to the indication.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A device, comprising:
a power module to receive a first wireless signal for conveying power from a charging device to the device;
a transmitter to transmit a second wireless signal for conveying information from the device to the charging device; and
a charging control module to cause the transmitter to transmit the second wireless signal based on an indication received from the power module.

2. The device of claim 1, wherein the power module comprises wireless charging circuitry to receive the first wireless signal, the first wireless signal being a radio frequency (RF) signal.

3. The device of claim 2, wherein the wireless charging circuitry comprises at least a coil to generate a charging current based on the RF signal.

4. The device of claim 1, wherein the second wireless signal is an infrared (IR) signal.

5. The device of claim 1, wherein the transmitter is part of the power module.

6. The device of claim 5, wherein the charging control module is part of the power module.

7. The device of claim 1, wherein the indication relates to at least one of the first wireless signal or device power condition.

8. The device of claim 1, wherein the information transmitted in the second wireless signal comprises at least one of status or instructions related to the indication.

9. The device of claim 1, further comprising a receiver to receive a third wireless signal for conveying information from the charging device to the device.

10. A method, comprising:
receiving a notification from a power module in a device that a first wireless signal has been received; and
causing a second wireless signal to be transmitted by a transmitter in the device, the second wireless signal initializing power transfer to the device via the first wireless signal.

11. The method of claim 10, wherein the first wireless signal is a radio frequency (RF) signal.

12. The method of claim 10, wherein the second wireless signal is an infrared (IR) signal.

13. The method of claim 10, further comprising receiving an indication from the power module, the indication relating to at least one of the first wireless signal or device power condition.

14. The method of claim 13, further comprising causing information to be transmitted via the second wireless signal, the information including at least one of status or instructions related to the indication.

15. At least one machine-readable storage medium having stored thereon, individually or in combination, instructions that when executed by one or more processors result in the following operations comprising:
receiving a notification from a power module in a device that a first wireless signal has been received; and
causing a second wireless signal to be transmitted by a transmitter in the device, the second wireless signal initializing power transfer to the device via the first wireless signal.

16. The medium of claim 15, wherein the first wireless signal is a radio frequency (RF) signal.

17. The medium of claim 15, wherein the second wireless signal is an infrared (IR) signal.

18. The medium of claim 15, further comprising instructions that when executed by one or more processors result in the following operations comprising:
receiving an indication from the power module, the indication relating to at least one of the first wireless signal or device power condition.

19. The medium of claim 18, further comprising instructions that when executed by one or more processors result in the following operations comprising:
causing information to be transmitted via the second wireless signal, the information including at least one of status or instructions related to the indication.
